(19) United States
(12) Patent Application Publication
(10) Pub. No.: US 2008/0008897 A1
(43) Pub. Date: Jan. 10, 2008

(54) MAGNETIC POWDER, SOFT MAGNETIC COMPOSITE, AND METHOD OF FORMING SAME

(76) Inventors: Takao IMAGAWA, Mito (JP); Yuichi Satsu, Hitachi (JP); Matahiro Komuro, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/774,238

(22) Filed: Jul. 6, 2007

(30) Foreign Application Priority Data
Jul. 6, 2006 (JP) 2006-186860

(51) Int. Cl. H01F 1/24; B22F 1/02; B22F 3/16

(52) U.S. Cl. 428/546; 419/38; 428/570

(57) ABSTRACT

A magnetic powder according to the present invention comprises powder made of the iron element as a main component, and an insulator covering the surface of the powder. The powder has a spherical shape or a smoothed surface. The insulator comprises rare earth fluorides, alkaline metal fluorides, or alkaline earth metal fluorides. A soft magnetic composite formed by using this magnetic powder can suppress its eddy current loss in a wide frequency band and can also suppress its hysteresis loss due to compressed residual distortion in soft magnetic powder.

The present application claims priority from Japanese application serial no. 2006-186860 filed on Jul. 6, 2006, the content of which is hereby incorporated by reference into this application.

### BACKGROUND OF THE INVENTION

1. Field of the Invention

The present invention relates to a soft magnetic composite formed of magnetic powder that includes the iron element by means of compression-molding and, more particularly, to a soft magnetic composite suitable for use in electric parts of, for example, motors.

2. Description of the Related Art

From the viewpoint of environments, electric cars have attracted much attention in recent years. These electric cars use a motor as the power source. A magnetic core (soft magnetic composite) in this type of motor largely affects the efficiency of the motor, so the core needs to be such that the iron loss is low and the magnetic flux density is high. Furthermore, these magnetic characteristics are required to keep high even in regions from low frequencies to high frequencies.

The above iron loss can be represented by a sum of the eddy current loss (Wₑ), which is largely related to the resistivity of the core, and the hysteresis loss (Wₕ), which is affected by distortion in iron powder, the distortion being caused in an iron powder by forming process and a subsequent process history. Here, let “f” be the frequency, let “Bₘ” be the excited magnetic flux density, let “ρ” be the resistivity, let “t” be the thickness of the material, and let “k₁” and “k₂” be coefficients. Then, the iron loss “W” is represented by equation (1).

W=Wₑ+Wₕ=(k₁Bₘ²t²/ρ)f²+k₂Bₘ^{1.6}f (1)

As shown in equation (1), the eddy current loss Wₑ is proportional to the square of the frequency f. Therefore, it is very important issue that the eddy current loss Wₑ is suppressed, in order to keep the magnetic characteristics high in the high frequency region by reducing the iron loss W of the core.

To achieve this object, a method of forming a soft magnetic composite is proposed, in which soft magnetic powder is mixed with insulating particles so as to form an insulating layer on the soft magnetic powder (e.g., see JP P2003-332116A). In another proposed method of forming a soft magnetic composite, an insulator, such as an oxide or a phosphate layer, is formed on Fe—Si soft magnetic powder and the resulting powder is compacted under pressure (e.g., see JP P2004-288983A). The use of atomized powder as soft magnetic powder suitable for a soft magnetic composite in the forming method is proposed (e.g., see JP P2006-24869A). A method of forming a magnetic material is also proposed, in which a fluoride compound is used as an insulator 82 that insulates a powder 81, as shown in FIG. 11 (e.g., see JP P2006-41203A). Aqueous atomized powder is used as the powder. Since the aqueous atomized powder can be easily compacted, a soft magnetic composite that has few voids on a cross section as shown in FIG. 12 can be formed.

The soft magnetic composites formed by the above methods each have an insulating layer (e.g., insulating layer 82a in FIG. 12) on a powder particle (e.g., the compressed powder particle 81a in FIG. 12), and thereby the eddy current can be suppressed, as compared with soft magnetic composites in which insulating layers are not formed. With the soft magnetic composite formed by the method described in JP P2003-332116A, however, even when soft magnetic powder is uniformly mixed with insulating particles, it is hard to form insulators on among all soft magnetic powder particles, so the insulation is not sufficiently achieved. As a result, the resistivity of the soft magnetic composite is low, which may cause a large eddy current loss (Wₑ). A possible countermeasure to solve this problem is to increase the ratio of insulating particles in order to stably form insulating layers, however the volume occupied by the soft magnetic powder decreases with increasing the ratio of insulating particles and the magnetic flux density of the soft magnetic composite may be thus lowed. To avoid the reduction in the magnetic flux density, it can be also considered that magnetic powder is compacted under a high pressure. However, this method is also problematic in that the high pressure may destroy the insulating layers and magnify distortion that is left in the soft magnetic powder during compression, and thus the eddy current loss (Wₑ) and the hysteresis loss (Wₕ) may increase.

When a soft magnetic composite is formed by using soft magnetic powder covered with an oxide layer as described in JP P2004-288983A and JP P2006-24869A, the soft magnetic composite, which is formed by compression-molding, has a high void ratio because the oxide layer is harder than the powder made of a metal material, thereby lowering the magnetic flux density of the soft magnetic composite. In this case as well, a method in which the compression-molding is performed under a high pressure as described above is conceivable, but it is also difficult to suppress the iron loss in the method, due to the reason described above. Besides, when the insulator covering the powder is an oxide such as SiO₂, as described in JP P2006-24869A, the oxide layer is pulverized into granular form during compression-molding because of brittle character of the oxide, and thereby a continuous insulating layer with a uniform thickness is not formed on a surface. Accordingly, the resistivity of the soft magnetic composite could not increase sufficiently. On the other hand, when phosphate is used as other examples described in JP P2004-288983A and JP P2006-24869A, the phosphate easily diffuses into iron at a temperature of higher than 500° C. during a heat treatment. Thereby it is difficult to conduct the heat treatment for reducing the hysteresis loss (Wₕ).

When rare earth fluorides, alkaline metal fluorides, or alkaline earth metal fluorides are used as a insulating layer of the magnetic powder, as described in JP P2006-41203A, to reduce the diffusion into iron during the above heat treatment, the fluoride has a superior heat resistance and almost no diffusion into iron occurs. When powder such as aqueous atomized powder, which is commonly used, is employed, however, the resistivity of the soft magnetic composite does not increase so much, as compared with Fe—Si alloy powder.

### SUMMARY OF THE INVENTION

Under these circumstances, it is an object of the present invention to provide magnetic powder used to form a soft magnetic composite and to provide a soft magnetic composite that can suppress the eddy current loss in a wide frequency band and can also suppress the hysteresis loss due to compressed residual distortion in soft magnetic powder. It is a further object of the present invention to provide a method of forming the soft magnetic composite.

As the results of detailed studying the magnetic powder and the soft magnetic composite by the inventors, it is found that a shape of magnetic powder including the iron element largely affects the performance of the soft magnetic composite, especially when rare earth fluoride, alkaline metal fluoride, or alkaline earth metal fluoride is used to form an insulator. Since the rare earth fluoride, alkaline metal fluoride, or alkaline earth metal fluoride is softer than the iron or iron alloy powder which is the base material of magnetic powder, an insulator formed of the fluorides easily follows the surfaces of iron particles after molding. Accordingly, if the surface of the soft magnetic powder is smooth, the insulating layer in the soft magnetic composite is uniformly formed along the grain boundaries of the magnetic powder when the powder is compressed. On the other hand, if the powder has convex projections, these projections, which are harder than the insulator, fracture the insulator and thereby the insulating layer in the soft magnetic composite is not uniformly formed.

Based on these new findings, the inventors have completed the invention as described below.

(1) According to an embodiment of the present invention, a magnetic powder comprises powder made of the iron element as a main component, and an insulator on a surface of the powder; wherein the powder has a spherical shape or a smoothed surface; and the insulator comprises rare earth fluorides, alkaline metal fluorides, or alkaline earth metal fluorides. Furthermore, a smoothed surface of the powder in the present invention means that the projections on the powder surface are mechanical worked and/or eliminated so as to make the surface smooth.

Since the rare earth fluorides, alkaline metal fluorides, or alkaline earth metal fluorides do not diffuse into the iron particle during heat treatment, and then distortion in the particle due to the compression relaxes during heat treatment, the hysteresis loss of the powder can be suppressed. Additionally, since the surface of the powder is free from projections and thereby smooth, the insulator can cover all the surface of the iron particle without undesired fracture.

In the above invention (1), the following modifications and changes can be made.

(i) The magnetic powder is obtained by milling gas atomized powder, reduced powder, or aqueous atomized powder.

For example, when aqueous atomized powder is milled, mechanical working or electric discharge machining is preferably selected as a smoothing process of the powder surface. The resulting powder has a spherical shape or a surface with few convexes and concaves, and thus there are fewer projections.

(ii) An average particle diameter of the magnetic powder is 50 to 200 μm.

(iii) An average thickness of the insulator is 20 nm or more but less than 400 nm.

When the average particle diameter of the powder is less than 50 μm, the domain-wall pinning effect by the particle surface (grain boundary) in the molded soft magnetic composite is enhanced. That leads the coercive force to increase and thus increasing the hysteresis loss. When the average particle diameter of the soft magnetic powder is more than 200 μm, the resistance of the molded soft magnetic composite using the powder hardly reduces unless the thickness of the fluoride layer is largely increased. When the thickness of the insulator is less than 20 nm, the tunnel current flows in the molded soft magnetic composite using the powder. That leads the insulation characteristic to deteriorate. When the thickness of the insulator is more than 400 nm, the spacing between neighbor magnetic powder particles in the molded soft magnetic composite is expanded and thus the particles are made magnetically independent. That leads a diamagnetic field to generate at the particle surface, and then the magnetic field of the interior of the particle is demagnetized, making it difficult for the magnetic field to saturate. As a result, a desired magnetic flux density of the soft magnetic composite cannot be obtained.

(2) According to another embodiment of the present invention, a soft magnetic composite is formed by compression-molding magnetic powder the main component of which is the iron element; wherein an insulating layer comprising rare earth fluorides, alkaline metal fluorides, or alkaline earth metal fluorides, and having a uniform thickness, is formed along grain boundaries of the compressed particles in the soft magnetic composite, in such a way that each compressed powder particle is covered with the insulating layer.

The soft magnetic composite described above can suppress the eddy current loss in a wide frequency band and can also suppress the hysteresis loss due to compressed residual distortion in soft magnetic powder.

In the above invention (2), the following modifications and changes can be made. (iv) Among each peripheral line of the compressed powder particles on a cross section of the molded soft magnetic composite, defining a peripheral line having an amplitude of 3% or more to the average particle diameter of the compressed powder particles as a waviness curve, when arbitrary segments circumscribing each waviness curve at two contacts on the waviness curve are drawn, the ratio of compressed powder particles in which the segments cross is preferably 20% or less of the all compressed powder particles.

(v) An average particle diameter of the compressed particles in the soft magnetic composite is 50 to 200 μm.

(vi) An average thickness of the insulating layer in the soft magnetic composite is 40 nm or more but less than 800 nm.

(vii) The density of the soft magnetic composite is 7.4 g/cm³ or more and 7.8 g/cm³ or less.

The soft magnetic composite of the present invention as described above can suppress the iron loss regardless of the frequency band, so it is preferable to use the soft magnetic composite as a core material of a motor. Furthermore, this type of motor is suitable as a driving motor in an electric car or the like.

(3) According to another embodiment of the present invention, a method of forming a soft magnetic composite comprises compression-molding magnetic powder; wherein the magnetic powder is made of the iron element as a main component, and an insulator on a surface of the magnetic powder is formed; wherein the magnetic powder has a spherical shape or a smoothed surface; and the insulator comprises rare earth fluorides, alkaline metal fluorides, or alkaline earth metal fluorides; wherein the magnetic powder is compression-molded so that the density of the soft magnetic composite becomes 7.4 g/cm³ or more and 7.8 g/cm³ or less.

When compression-molding is performed in such a way that this density is obtained, residual stress is not substantially recognized. In addition, when the molded soft magnetic composite is annealed at a temperature of 600° C., the magnetic properties are such that the hysteresis loss Wₕ is 15 W/kg or less, the eddy current loss WE is 20 W/kg or less, thus the iron loss W is 35 W/kg or less, and the resistivity is 200 μΩ·cm or more under the conditions of 1 T and 400 Hz. Accordingly, a soft magnetic composite having magnetic properties suitable for electric motors and the like can be obtained.

In the above invention (3), the following modifications and changes can be made.

(viii) The compression-molded soft magnetic composite is further heat treated at temperatures of 600 to 700° C.

When the heat treatment temperature (annealing temperature) is from 600 to 700° C., the coercive force is small and the hysteresis loss tends to decrease. Since the resistivity decreases monotonously and the iron loss slightly increases with increasing the heat treatment temperature, the heat treatment temperature is preferably 700° C. or lower.

The insulator is preferably NdF₃, for example; LaF₃, CeF₃, PrF₃, SmF₃, EuF₃, GdF₃, TbF₃, DyF₃, HoF₃, ErF₃, and Luf₃ may also be used. MgF₂, CaF₂, ScF₂, SrF₂, YF₂, BaF₂, LiF₂, and combinations of the above compounds provide the same effect.

(Advantages of the Invention)

According to the present invention, it is possible to increase the heat resistance of the soft magnetic composite. Further, it is possible to suppress the eddy current loss in a wide frequency band, and the hysteresis loss due to residual distortion in the soft magnetic powder.

### BRIEF DESCRIPTION OF THE DRAWINGS

FIG. 1 is a schematic illustration showing a cross-sectional view of the magnetic powder in a preferred embodiment according to the present invention.

FIG. 2 is an enlarged view of the main part of a soft magnetic composite formed by use of the magnetic powder shown in FIG. 1.

FIG. 3 is a schematic view for illustrating evaluation of waviness.

FIG. 4 is a graph representing the relationship between the average particle diameter of powder used to form soft magnetic composites and the coercive force of the soft magnetic composites in Example 3, Comparative example 2, and Comparative example 3.

FIG. 5 is a graph representing the relationship between the average particle diameter of magnetic powder used to form the soft magnetic composites and the resistivity of the soft magnetic composites in Example 3, Comparative example 2, and Comparative example 3.

FIG. 6 is a graph representing the relationship between the average thickness of insulator on magnetic powder used to form soft magnetic composites and the resistivity of the soft magnetic composites in Example 4, Comparative example 4, and Comparative example 5.

FIG. 7 is a graph representing the relationship between the average thickness of insulator on magnetic powder used to form the soft magnetic composites and the magnetic flux density of the soft magnetic composites in Example 4, Comparative example 4, and Comparative example 5.

FIG. 8 is a graph representing the relationship between heat treatment temperature performed for the soft magnetic composites and the coercive force of the soft magnetic composites in Example 5, Comparative example 6, and Comparative example 7.

FIG. 9 is a graph representing the relationship between heat treatment temperature performed for the soft magnetic composites and the resistivity of the soft magnetic composites in Example 5 and Comparative examples 6 to 8.

FIG. 10 is a schematic illustration showing a radial cross-sectional view of a motor having a hollow shaft using the soft magnetic composite in a preferred embodiment according to the present invention.

FIG. 11 is a schematic illustration showing a cross-sectional view of magnetic powder using conventional aqueous atomized powder.

FIG. 12 is an enlarged view of the main part of a soft magnetic composite formed by use of the magnetic powder shown in FIG. 11.

### DETAILED DESCRIPTION OF THE PREFERRED EMBODIMENTS

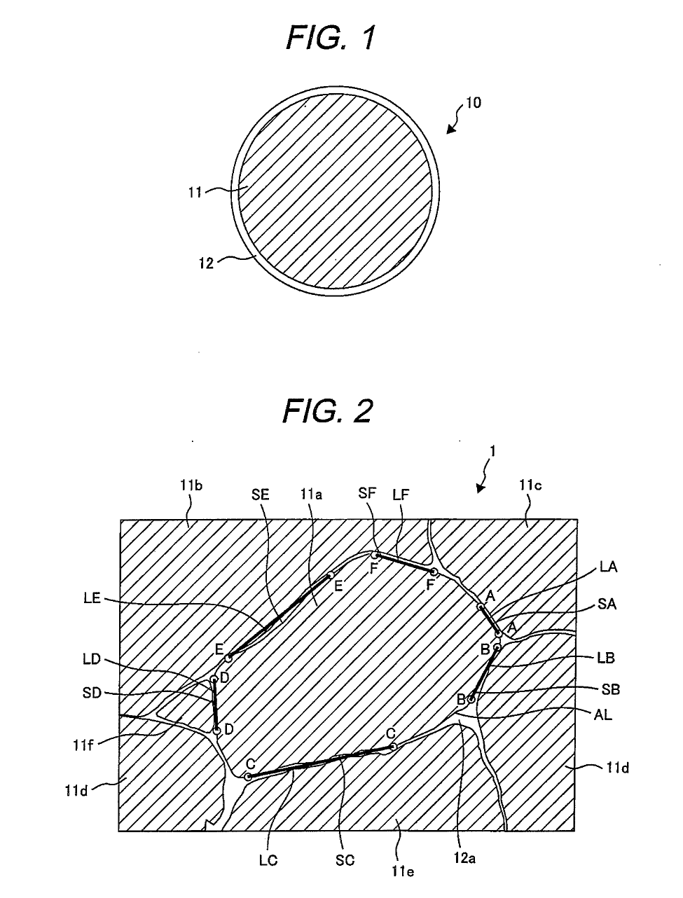

A preferred embodiment of the inventive magnetic powder and the inventive soft magnetic composite formed by use of the magnetic powder will be described below with reference to the drawings. FIG. 1 is a schematic illustration showing a cross-sectional view of the inventive magnetic powder in a preferred embodiment according to the present invention. FIG. 2 is an enlarged view of the main part of a soft magnetic composite formed by use of the magnetic powder shown in FIG. 1.

As shown in FIG. 1, the magnetic powder 10 in this embodiment comprises powder 11, the surface of which is covered with an insulator 12. The powder 11 is soft magnetic powder, the main component of which is the iron element, and which has a spherical shape or a smoothed surface. Examples of the spherical powder include gas atomized powder; examples of the powder with a smoothed surface include powder resulting from milling, e.g., aqueous atomized powder by mechanical working or electric discharge machining, powder resulting from electrolytic deposition, and other powder machined so that convexes and concaves or waviness is reduced (planarized, flattened). The average particle diameter of the powder 11 is preferably within the range of 50 to 200 μm. The insulator 12 is a film comprising rare earth fluorides, alkaline metal, fluorides or alkaline earth metal fluorides; the average thickness is preferably within the range of 20 nm or more to less than 400 nm.

The magnetic powder obtained as described above is filled into a desired mold, and is compressed so that the density becomes 7.4 g/cm³ or more and 7.8 g/cm³ or less, more preferably 7.5 g/cm³; during the compression-molding process, the magnetic powder may be heated to a prescribed temperature, if necessary. In the soft magnetic composite formed by the compression-molding, as shown in FIG. 2, each powder 11 is denoted a compressed powder particle 11a, 11b, . . . , and the insulator 12 is denoted as an insulating layer 12a. The insulating layer 12a has an approximately uniform thickness and covers the compressed powder particles 11a, 11b, and the like along their surfaces (grain boundaries between the particles). Due to the average particle diameter of the powder 11 and the average thickness of the insulator 12, the average particle diameter of the compressed powder particles 11a, 11b, . . . is preferably within the range of 50 to 200 μm and the average thickness of the insulating layer 12a is preferably within the range of 40 nm or more to less than 800 nm, which is twice of the average thickness of the insulator 12.

When the average particle diameter of the compressed powder particles 11a, 11b, . . . in the soft magnetic composite is more than 200 μm (that is, when the magnetic powder 10 including the powder 11 with an average particle diameter of more than 200 μm is used for compression-molding), unless the average thickness of the insulator 12 increases largely, the insulating property after-mentioned of the compression-molded soft magnetic composite is degraded, depending on the frequency range in which the soft magnetic composite is used. When the average particle diameter of the compressed powder particles 11a, 11b, . . . is less than 50 μm (that is, when the magnetic powder 10 including the powder 11 with an average particle diameter of less than 50 μm is used for compression-molding), the domain-wall pinning effect at the particle surface increases, increasing the coercive force and thus increasing the hysteresis loss. Accordingly, the average particle diameter of the powder 11 (average particle diameter of the powder particles 11a, 11b, . . . of the soft magnetic composite) is preferably 50 to 200 μm.

When the average thickness of the insulating layer 12a is less than 40 nm (that is, when the magnetic powder 10 including the insulator 12 with an average thickness of less than 20 nm is used for compression-molding), the tunnel current easily flows in the compression-molded soft magnetic composite, degrading the insulation characteristic. On the other hand, when the average thickness of the insulating layer 12a is more than 800 nm (that is, when the magnetic powder 10 including the insulator 12 with an average thickness of more than 400 nm is used for compression-molding), the spacing between neighbor magnetic powder particles in the soft magnetic composite spreads and the particles are made magnetically independent. A diamagnetic field generates at the particle surface and then demagnetizes the magnetic field of the interior of the particle, making it difficult for the magnetic field to saturate. As a result, a desired magnetic flux density of the soft magnetic composite cannot be obtained. Accordingly, the average thickness of the insulator 12 of the magnetic powder 10 is preferably 20 nm or more but less than 400 nm; the preferable average thickness of the insulating layer is thus 40 nm or more but less than 800 nm. The thickness of the insulator 12 can be controlled by changing a temperature in an insulator formation process or changing a composition in the treatment liquid.

High mechanical strength, if required for the soft magnetic composite, can be obtained more effectively by applying surface treatment to the powder 11 which has undergone phosphate treatment and then by executing a annealing process (heat treatment) after compression-molding. As the surface treatment, an inorganic binder (e.g., a water solution of Na₂O/SiO₂ based liquid glass or a phosphate/boric-acid/magnesia based water solution) can be used. When the annealing temperature (heat treatment temperature) is 600° C. or more, the inorganic binder softens during the annealing process, the surface of the powder 11 is extensively wetted by the inorganic binder material, and the inorganic binder solidifies upon the completion of the annealing process, thereby increasing the mechanical strength of the soft magnetic composite. In this case, the ratio of the volume of the solidified inorganic binder to the volume of the soft magnetic composite must be 3 vol. % or less in order to assure the magnetic characteristic.

In the soft magnetic composite 1 obtained as described above, the rare earth fluorides, alkaline metal fluorides, or alkaline earth metal fluorides do not diffuse into the iron particles during the heat treatment, suppressing the hysteresis loss. Furthermore, since the insulating layer 12a, with an approximately uniform thickness, comprising rare earth fluorides, alkaline metal fluorides, or alkaline earth metal fluorides is formed, the eddy current loss can be suppressed in a wide frequency band and the hysteresis loss due to compressed residual distortion in soft magnetic powder can also be suppressed.

Examples in the present invention will be given below.

### EXAMPLE 1

### <Forming a Soft Magnetic Composite>

### [Powder]

Gas atomized powder, which comprises pure iron and has an average particle diameter of 100 μm, was prepared as spherical, soft powder.

[Preparing Treatment Liquid for Forming an Insulator]

Treatment liquid for forming an insulator on the surface of the gas atomized powder was prepared by a procedure described below.

(1) Four grams of Nd acetate was added to 100 ml of water, and completely dissolved in water by use of a shaker or ultrasonic agitator.

(2) Hydrofluoric acid diluted to 10% was gradually added by an amount equal to an equivalent in a chemical reaction by which NdF₃ is produced.

(3) A solution in which gelled NdF₃ precipitated was stirred with the ultrasonic agitator for one hour or more.

(4) The solution was centrifuged at a rotation of 4000 to 6000 rpm, after which the supernatant fluid was removed and methanol of the same volume was added.

(5) The methanol solution including gelled NdF₃ was stirred to obtain complete suspension. The suspension was further stirred with the ultrasonic agitator for one hour or more.

(6) Operations in (4) and (5) were repeated three to ten times until anions such as acetate ions or nitrate ions were not detected.

(7) Finally, solated NdF₃ was obtained. Methanol solution, in which 1 gram of NdF₃ was dissolved per 4 ml, was used as treatment liquid.

[Insulator Forming Process and Compression-Molding]

A soft magnetic composite was formed as described below, by using the gas atomized powder and the above treatment liquid.

(1) In order to form magnetic powder, the surface of which is covered with an insulator, 8 ml of NdF₃ treatment liquid was added to 40 g of gas atomized powder with an average particle diameter of 100 μm, and mixed until it was confirmed that the entire iron powder was wetted.

(2) The methanol solvent was removed from the iron powder treated with NdF₃ added in (1) under a reduced pressure of 2 to 5 Torr.

(3) The magnetic powder, from which the solvent was removed in (2), was moved to a quartz boat, and heated at 200° C. for 30 minutes and then at 350° C. for 30 minutes under a reduced pressure of 5×10⁻⁵ Torr.

(4) When a large amount of the magnetic powder was necessary, the amount of treatment liquid was increased according to the necessary amount of the magnetic powder, and iron powder, which was the raw material, was treated up to the necessary amount.

(5) The magnetic powder resulting from the heat treatment performed in (3) was filled in a superhard mold. Then, a molding load of 18 tons was applied to the magnetic powder so that the density of the soft magnetic composite became 7.5 g/cm³. The molded soft magnetic composite for magnetism measurement was formed into a ring core with an outer diameter of 18 mm and an inner diameter of 10 mm.

(6) The magnetic powder resulting from the heat treatment performed in (3) was filled in another superhard mold. A molding load of 15 tons was applied to the magnetic powder so that the density of the soft magnetic composite became 7.5 g/cm³. The molded soft magnetic composite for resistivity measurement was formed into a rectangular parallelepiped core with a size of 10 mm×10 mm.

(7) The samples prepared in (5) and (6) were heated at 600° C. under a reduced pressure of 5×10⁻⁵ Torr. The relative densities of these samples were 95% or more.

<Evaluation Method>

[Observation of Cross Section Microstructure]

A cross section of the formed soft magnetic composite was observed using a microscope.

[Evaluation of Waviness]

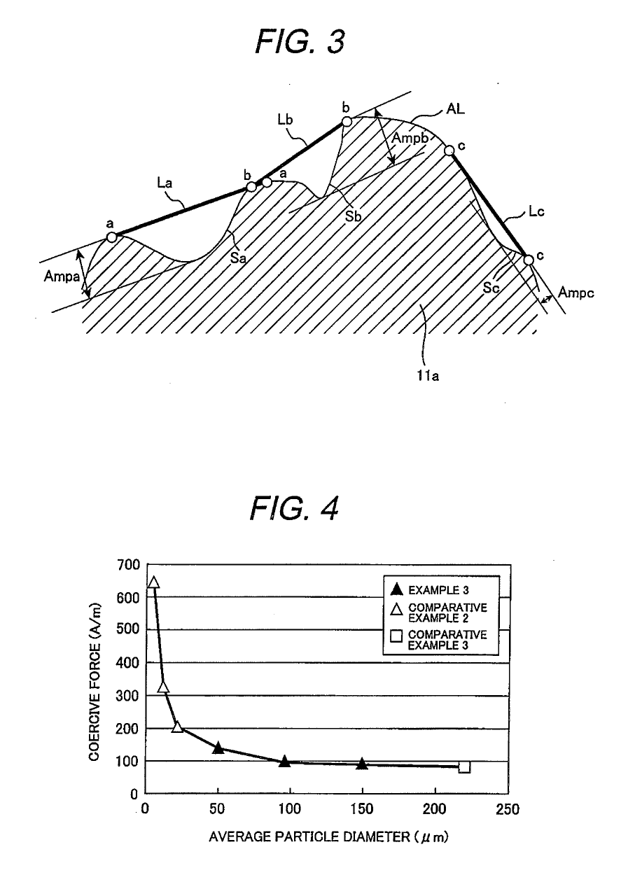

Waviness was evaluated by a method described below. An exemplum of a cross section microstructure is shown in FIG. 3. On a cross section of the soft magnetic composite, amplitudes Ampa, Ampb, Ampc, . . . are 3% or more of the average particle diameter of the compressed powder particles. As shown in FIG. 3, portions of a peripheral line AL of a compressed powder particle, which have the amplitudes Ampa, Ampb, Ampc, . . . , are defined as waviness curves Sa, Sb, Sc, and so on. Out of the tangents circumscribing the convexes of all waviness curves Sa, Sb, Sc, . . . defined for a single compressed powder particle 11a, some tangents are aligned to each other. Each two contacts ((a, a), (b, b), . . . ) of aligned tangents on circumscribed waviness curves are extracted and the each two contacts are connected with a straight line (a-a, b-b, . . . ) and the straight line is defined as segment La, Lb, and so on. In other words, arbitrary segments (La, Lb, . . . ) circumscribing each waviness curve (Sa, Sb, Sc, . . . ) at two contacts ((a, a), (b, b), . . . ) on the waviness curve are drawn in a cross sectional view of a compressed powder particle 11a. In each compressed powder particle (11a, 11b, . . . ), some segments (La, Lb, . . . ) may cross each other. The ratio of the number of compressed powder particles including crossing segments to the total number of compressed powder particles was confirmed.

FIG. 2 shows an example of waviness evaluation in this example. In FIG. 2, the above evaluation was performed for the compressed powder particle 11a. SA, SB, SC . . . in the drawing correspond to the above waviness curves. A, B, C correspond to the above contacts. LA, LB, LC, . . . correspond to the above segments. Table 1 shows evaluation result (ratio of intersections).

[Measurement of Resistivity and Magnetic Flux Density]

The above-mentioned rectangular parallelepiped soft magnetic composite prepared for resistivity measurement was used to measure its resistivity and total loss by an ordinary method (e.g., four-probe resistive measurement and magnetic characteristics measurement). Table 1 also indicates the measurement results.

### EXAMPLE 2

A soft magnetic composite was formed in the similar way as in Example 1. Example 2 differs from Example 1 in that, aqueous atomized powder rather than gas atomized powder was pulverized with a ball mill to obtain magnetic powder, the surface of the powder was smoothed by mechanical working, and the resulting powder was classified so that powder with an average diameter of 150 μm was used. The soft magnetic composite in Example 2 was evaluated in the same evaluation method as in Example 1. Table 1 shows the evaluation results.

### COMPARATIVE EXAMPLE 1

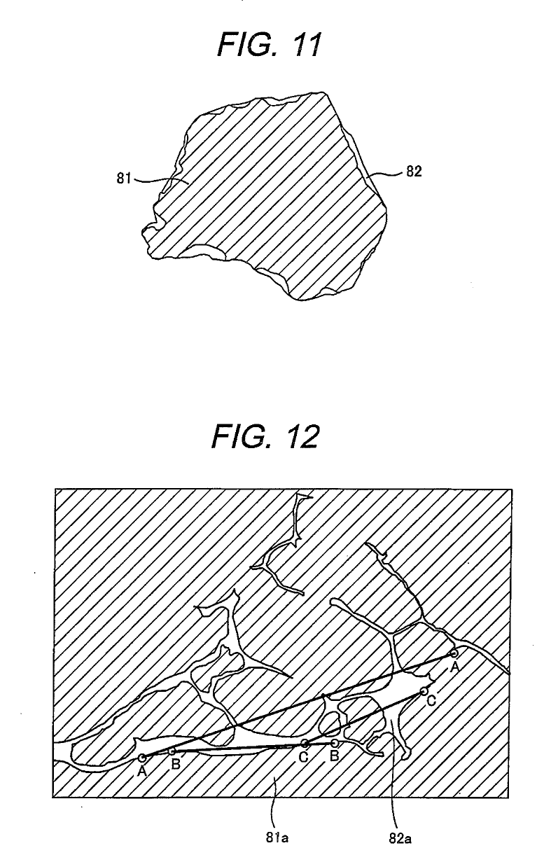

A soft magnetic composite was formed in the similar way as in Example 1. Comparative example 1 differs from Example 1 in that the aqueous atomized powder without a smoothing process of the particle surface, which has been described above with reference to FIG. 11, was used as magnetic powder. The soft magnetic composite in Comparative example 1 was evaluated in the same evaluation method as in Example 1. Table 1 shows the evaluation results.

TABLE 1

| | | Example 2 | Comparative |
|---|---|---|---|
| | Example 1 | (worked aqueous | example 1 |
| | (gas atomized | atomized | (aqueous |
| | powder) | powder) | atomized powder) |
| Ratio of | 1/22 (5%) | 3/19 (16%) | 18/18 (100%) |
| intersections | | | |
| Resistivity | 3.7 μΩ · m | 2.2 μΩ · m | 0.7 μΩ · m |
| Total loss | 28 W/kg | 33 W/kg | 80 W/kg |

(Result 1)

The observation of the cross section microstructure indicates that the compressed powder particles in the soft magnetic composites in Examples 1 and 2 are not complete sphere, but the boundary between the particle and the insulating layer is mostly flat and the thickness of the insulating layer is approximately uniform. There are no cracks, which are usually found in Fe—Si based cores. For the soft magnetic composites in Examples 1 and 2, an insulating layer, comprising rare earth fluorides, alkaline metal fluorides, or alkaline earth metal fluorides, with an approximately uniform thickness is formed along the surface of each compressed powder particle in such a way that the insulating layer covers the particle, as compared with that in Comparative example 1. The insulating layer is formed continuously and has a little waviness. For the soft magnetic composite in Comparative example 1, the thickness of the insulating layer is not uniform and there are no insulating layers between some compressed powder particles.

(Result 2)

As shown in Table 1, the soft magnetic composites in Examples 1 and 2 have a few compressed powder particles including crossing segments. On the other hand, for the soft magnetic composite in Comparative example 1, segments A-A, B-B, C-C and like, as shown in FIG. 12 as an example, are drawn and segments cross each other in all compressed powder particles.

(Result 3)

As indicated in Table 1, the resistivity of the soft magnetic composites in Examples 1 and 2 are higher than that in Comparative example 1, and the total loss in Comparative example 1 is higher than that in the other examples.

(Discussion 1)

The soft magnetic composites in Examples 1 and 2 were formed from spherical powder or powder the surface of which was smoothed, and thus had a little waviness. The soft magnetic composite in Comparative example 1 was formed from powder of indefinite shapes, such as non-worked aqueous atomized powder, so waviness was generated on surfaces and fracture regions of the insulating layer were also formed. It can be considered that these microstructural features of the soft magnetic composites lead to above Results 1 to 3. It can be also considered that the insulator before being compressed is locally present in concave parts of the particle in Comparative example 1. That is another possible reason why the thickness of the insulating layer is not uniform in Comparative example 1 (see FIG. 12). The results of Examples 1 and 2 indicate that the resistivity and the total loss in these examples are within a usable range and that the ratio of the number of particles including the intersections to the total number of particles measured is less than 20%. Accordingly, it strongly suggested that soft magnetic composites suitable for practical use can be obtained by using the magnetic powder. On the other hand, in Comparative example 1, the thickness of the insulating layer is not uniform and there is much waviness, electrolysis concentration easily occurs in the core. For this reason, it can be thought that the resistivity of the soft magnetic composite decreased and thus the total loss increased. Although NdF₃ was used to form an insulator in above examples, insulators comprising other fluorides, that is, rare earth fluorides, alkaline metal fluorides, or alkaline earth metal fluorides can offer the same effect.

In order to obtain a desired magnetic characteristic reliably, the soft magnetic composite is preferably such that the density ratio of the iron in the soft magnetic composite is 95% or more and that the ratio of the volume occupied by the soft magnetic powder in the soft magnetic composite is 90% or more. Accordingly, a saturation flux density almost equal to 1.7 T (tesla), which is the saturation flux density of a silicon steel plate that has been widely used, is obtained. Here, the ratio of the volume occupied by the soft magnetic powder means the ratio of the volume of the soft magnetic powder itself, excluding the insulating layer.

### EXAMPLE 3

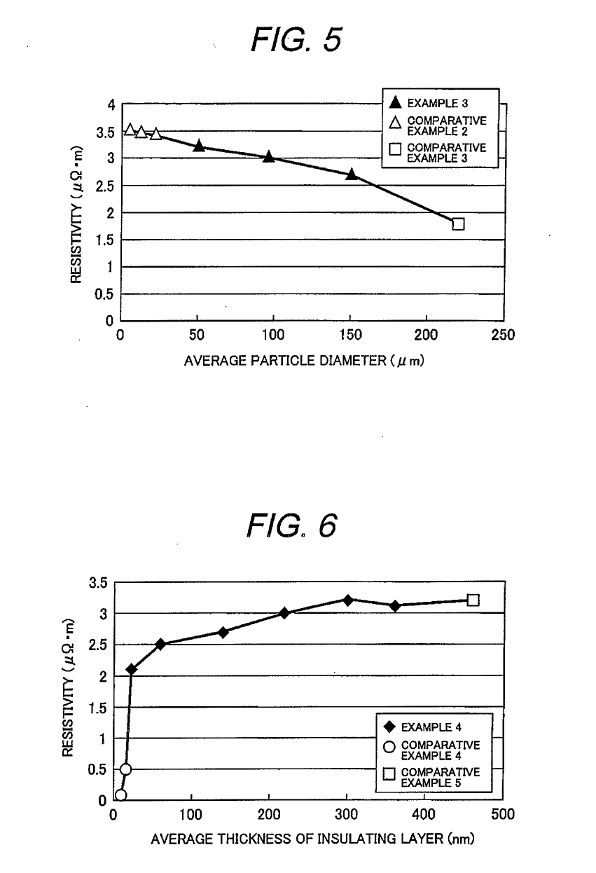

Soft magnetic composites were formed in the similar way as in Example 1. However, as shown in FIG. 4, Example 3 differs from Example 1 in that an NdF₃ layer was formed by using gas atomized powder which was classified so that the average particle diameter is 50 μm or more but less than 200 μm, and then heated at 600° C., as soft magnetic powder. The amount of powder to be used was changed according to the size of the powder so that the average thickness of NdF₃ (insulating layer) of each soft magnetic composite became 60 nm. The coercive force of the soft magnetic composite was measured in the same way as in Example 1. The result of the coercive force is shown in FIG. 4. The resistivity was also measured in the same way as in Example 1. The result of the resistivity is shown in FIG. 5.

### COMPARATIVE EXAMPLES 2 AND 3

Soft magnetic composites were formed in the similar way as in Example 3. However, as shown in FIG. 4, Comparative examples 2 and 3 differ from Example 3 in that soft magnetic powder with a different average particle diameter was used; in Comparative example 2, the average particle diameter is 5 μm or more but less than 50 μm (specifically, 10 μm, 16 μm, and 22 μm); in Comparative example 3, the average particle diameter is 220 μm. The coercive force and resistivity of these soft magnetic composites were measured in the same way as in Example 1. The results are shown in FIGS. 4 and 5.

(Result 4)

As shown in FIG. 4, the coercive force of the soft magnetic composite in Example 3 is smaller than that in Comparative example 2. The coercive force of the soft magnetic composites in Comparative example 3, Example 3, and Comparative example 2 is higher in that order (the coercive force increases with decreasing the average powder particle diameter). As shown in FIG. 5, the resistivity of the soft magnetic composite in Example 3 is higher than that in Comparative example 3. The resistivity of the soft magnetic composites in Comparative example 2, Example 3, and Comparative example 3 is lower in that order (the resistivity decreases with increasing the average powder particle diameter).

(Discussion 2)

As described above, the coercive force increased with decreasing the average powder particle diameter (see FIG. 4). As a reason of this result, it can be considered that the ratio of the surface of the soft magnetic powder became large and thus the effect of the domain-wall pinning of became large. In order to decrease the coercive force and reduce the hysteresis loss, the average particle diameter is preferably 50 μm or more as in the soft magnetic composites in the third example. Furthermore, the resistivity of the soft magnetic composite decreased with increasing the average powder particle diameter, as shown in FIG. 5. As a reason of this result, it can be thought that the number of particles in the soft magnetic composite decreases. Since the resistivity of a soft magnetic composite used in a motor or another unit is 2 μΩ·m or more, a preferable average particle diameter can be estimated of 200 μm or less.

### EXAMPLE 4

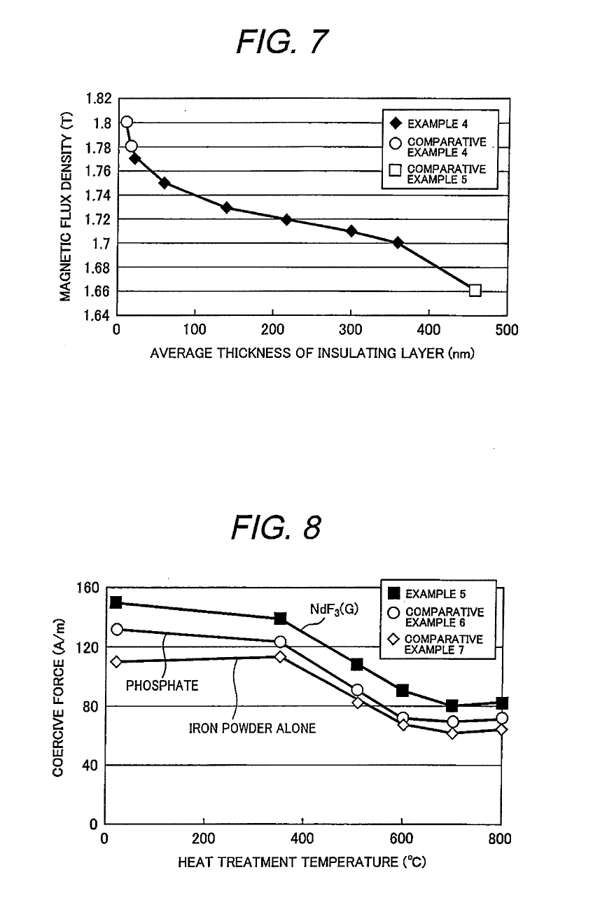

Soft magnetic composites were formed in the similar way as in Example 1. However, Example 4 differs from Example 1 in that soft magnetic powder with an average particle diameter of 96 μm was used and that insulators with an average thickness of 20 to 400 nm were formed as shown in FIG. 6. The thickness of the insulator formed on the soft magnetic powder was adjusted by changing the amount of powder treated and the number of the treatment times; the insulator thickness increases approximately in proportion to the number of treatments. The resistivity of the soft magnetic composites thus formed was measured in the same way as in Example 1. The result of the resistivity is shown in FIG. 6. The magnetic flux density of the soft magnetic composite was also measured by an ordinary method (e.g., magnetic characteristics measurement) under the excited magnetic field of 10,000 A/m. The result of the magnetic flux density is shown in FIG. 7.

### COMPARATIVE EXAMPLES 4 AND 5

Soft magnetic composites were formed in the similar way as in Example 4. However, as shown in FIG. 6, Comparative examples 4 and 5 differ from Example 4 in that insulators with a different thickness were used; in Comparative example 4, the thickness of the insulators was less than 20 nm (specifically, 10 nm and 16 nm); in Comparative example 5, the thickness of the insulator was more than 400 nm (specifically, 440 nm). The resistivity and magnetic flux density of each soft magnetic composite were measured in the same way as in Example 4 and Comparative example 2. The results are shown in FIGS. 6 and 7.

(Result 5)

As shown in FIGS. 6 and 7, the resistivity and magnetic flux density of the soft magnetic composites in Comparative example 4, Example 4, and Comparative example 5 is higher in that order (the resistivity increases with increasing the average thickness), and the magnetic flux density is lower in that order (the magnetic flux density decreases with increasing the average thickness).

(Discussion 3)

Since the resistivity and magnetic flux density of a soft magnetic composite used in a motor or another unit are respectively 2 μΩ·m or more and 1.7 T or more, it can be considered that a preferable average thickness of the insulator is 20 nm or more but less than 400 nm, as indicated in Example 4. When the thickness of the insulator is less than 20 nm, the tunnel current flows between the molded magnetic particles in the molded soft magnetic composite, lowering the insulation characteristic. On the other hand, when the thickness of the insulator is more than 400 nm, the spacing between neighbor magnetic particles in the molded soft magnetic composite is expanded and thus the particles are made magnetically independent. That leads a diamagnetic field to generate at the particle surface, and then the magnetic field of the interior of the particle is demagnetized, making it difficult for the magnetic field to saturate. As a result, it can be regarded that a desired magnetic flux density cannot be obtained and that the cause of the reduction in the magnetic flux density is not deterioration of particles due to, for example, oxidization.

### EXAMPLE 5

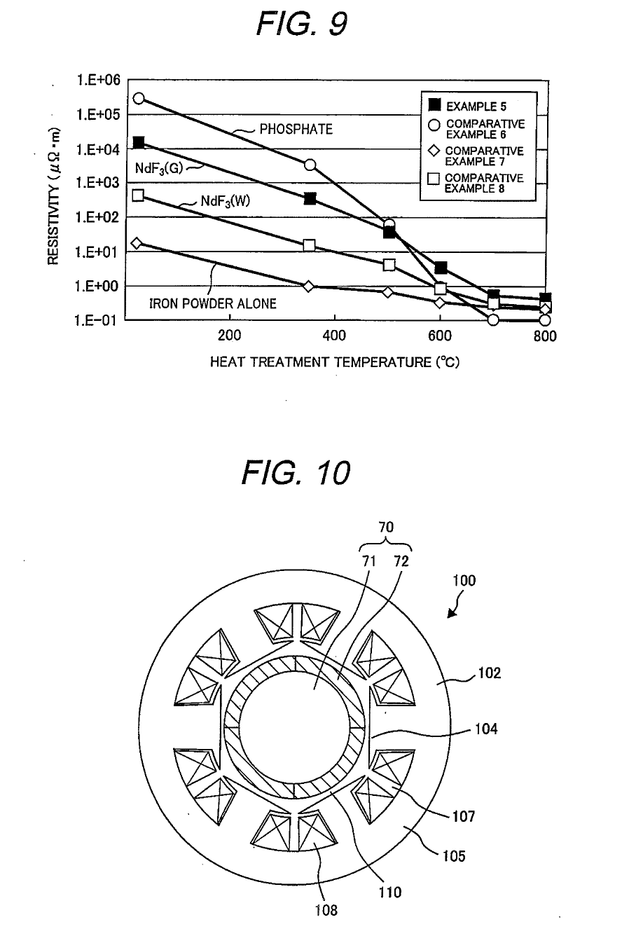

Soft magnetic composites were formed in the similar way as in Example 1. However, as shown in FIG. 8, Example 5 differs from Example 1 in that the temperature in the heat treatment process performed after the compression-molding process is changed. The coercive force and resistivity of these soft magnetic composites were measured. The results are shown in FIGS. 8 and 9.

### COMPARATIVE EXAMPLES 6 TO 8

Soft magnetic composites were formed in the similar way as in Example 5. However, Comparative example 6 differs from Example 5 in that a phosphate layer is provided instead of the NdF₃ insulator; Comparative example 7 differs from Example 5 in that only iron powder is used without an insulator being coated on the magnetic powder; Comparative example 8 differs from Example 5 in that aqueous atomized powder is used instead of gas atomized powder. The coercive force and resistivity of these soft magnetic composites were measured in the same way as in Example 5. The results are shown in FIGS. 8 and 9.

(Result 6)

The coercive force of soft magnetic composites in Example 5 is almost the same level as those of other soft magnetic composites over an entire temperature region, as shown in FIG. 8. Furthermore, as shown in FIG. 9, the resistivity of all soft magnetic composites decreases with increasing the heat treatment temperature. Among the soft magnetic composites heat-treated at 600° C. or more, however, the resistivity in Example 5 is highest. The coercive force of all soft magnetic composites heat-treated at 600° C. or more decreases and is steady.

(Discussion 4)

It can be regarded from the above results that heat treatment is preferably performed at 600° C. or more in order to lower the coercive force. The soft magnetic composites in Comparative example 6, in which phosphate is used, can be said to be inappropriate because their resistivity rapidly decrease during a heat treatment process at 500° C. or more. When an NdF₃ layer is used as the insulating layer as in Example 5, a relatively high resistivity can be maintained at up to 700° C. Accordingly, it can be thought that the heat treatment process is preferably performed at 600 to 700° C.

### EXAMPLE 6

The soft magnetic composite in Example 1 was used for a stator 102 of a motor 100 as shown in FIG. 10. Specifically, on a radial cross-section of the motor in FIG. 10, the stator 102 of the motor is a lamination of stator iron cores, each of which comprises teeth 104 and a core back 105; close-packed wirings 108 are disposed around the teeth 104, each close-packed wiring 108 being provided in a slot 107 between each two teeth 104. Since the motor has four poles and six slots, the slot pitch is 120 electrical degrees. A rotor 70 having permanent magnets 72 on the outer peripheral surface of a rotor shaft 71 is inserted into a shaft hole or rotor insertion hole 110. The stator 102 is made of iron powder that is coated with an NdF₃ insulator with a thickness of 20 nm, cold-molded, and then heated at 600° C. Furthermore, soft magnetic composites were formed in the same way as in Example 1. The iron loss, magnetic flux density, and other factors were evaluated.

### COMPARATIVE EXAMPLE 8

Soft magnetic composites were formed in the similar way as in Example 6. However, Comparative example 8 differs from Example 6 in that aqueous atomized powder that was not worked for smoothing was used as magnetic powder. These soft magnetic composites were evaluated in the same way as in Example 6.

(Result 7)

With the soft magnetic composites in Example 6, the ratio of the volume occupied by the core is 80%, and the saturation flux density of the soft magnetic composites is 1.77 T. It was confirmed that when iron powder that had undergone NdF₃ treatment was used for the stator 102, the efficiency of a motor increased as compared with a case in which a laminated structure of 0.15-mm-thick silicon steel plates was used. Since the saturate magnetic flux density when an NdF₃ insulator is formed is the same level to that of the silicon steel plate, there was no problem on the magnetic saturation. The iron loss of the soft magnetic composites in Example 6 was half or less than that in Comparative example 8. For the motor in Example 6 in which the stator 102 was made of iron powder formed by applying NdF₃ to gas atomized powder, an advantage by high resistivity was confirmed; the temperature of the heat generated at a rotation of 3000 rpm was lowered by 20° C., as compared with a case in which non-smoothed aqueous atomized powder was used.

(Discussion 5)

The reason why a soft magnetic composite is used for the stator 102 is that this type of motor has a plurality of poles and thus the eddy current generated by a rotating magnetic field must be low. The rotor is preferably formed by molding a powder material with a compression-molding means; the molded structure has a bond magnet portion mainly comprising a bonding material and magnet powder, and has a soft magnetic portion mainly comprising a bonding material and soft magnetic powder; at least one surface of the magnetic poles of the bond magnet portion is mechanically joined to the soft magnetic portion. The bond magnet is formed for each segment in a temporary molding process. Accordingly, the rotor is more preferably formed as a rotor for a motor by giving anisotropy during the temporary molding process, by forming a rotor with a plurality of poles from the temporary structure having the anisotropy in a final molding process, and by magnetizing the rotor in a magnetic field.

### Advantages of the Embodiments

According to the preferred embodiments of the present invention, heat treatment for recovering the magnetic properties deteriorated during a molding process can be performed with an eddy current loss suppressed. The present invention is preferably applied to cores requiring a small hysteresis loss and/or a small eddy current loss, motor iron cores requiring a high magnetic flux density, solenoid cores (fixed iron cores) incorporated into electronically controlled fuel injectors of diesel engines and gasoline engines, and core parts for plunger and other actuators. The present invention is also suitable for motors in air-conditioners and other home electric appliances, powder generators for distributed power supplies, and motors for driving hybrid electric vehicles (HEVs).

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A magnetic powder, comprising:
powder made of the iron element as a main component, and an insulator on a surface of the powder, wherein:
the powder has a spherical shape or a smoothed surface; and
the insulator comprises rare earth fluorides, alkaline metal fluorides, or alkaline earth metal fluorides.

2. A magnetic powder according to claim 1, wherein:
the powder is obtained by milling gas atomized powder, reduced powder, or aqueous atomized powder.

3. A magnetic powder according to claim 1, wherein:
an average particle diameter of the powder is 50 to 200 μm.

4. A magnetic powder according to claim 3, wherein:
an average thickness of the insulator is 20 nm or more but less than 400 nm.

5. A soft magnetic composite formed by compression-molding magnetic powder the main component of which is the iron element, wherein:
an insulating layer comprising rare earth fluorides, alkaline metal fluorides, or alkaline earth metal fluorides, and having a uniform thickness, is formed along grain boundaries of the compressed particles in the soft magnetic composite, in such a way that each compressed particle is covered with the insulating layer.

6. A soft magnetic composite according to claim 5, wherein:
among each peripheral line of the compressed powder particles on a cross section of the molded soft magnetic composite, defining a peripheral line having an amplitude of 3% or more to the average particle diameter of the compressed powder particles as a waviness curve;
when arbitrary segments circumscribing each waviness curve at two contacts on the waviness curve are drawn, the ratio of compressed powder particles in which the segments cross is 20% or less of the all compressed powder particles.

7. A soft magnetic composite according to claim 5, wherein:
an average particle diameter of the compressed particles in the soft magnetic composite is 50 to 200 μm.

8. A soft magnetic composite according to claim 5, wherein:
an average thickness of the insulating layer is 40 nm or more but less than 800 nm.

9. A soft magnetic composite according to claim 7, wherein:
the density of the soft magnetic composite is 7.4 g/cm³ or more and 7.8 g/cm³ or less.

10. A motor, wherein:
the soft magnetic composite of claim 7 is used as the material of a core.

11. An electric car, wherein:
the motor of claim 12 is used as a driving motor.

12. A method of forming a soft magnetic composite comprising compression-molding magnetic powder, wherein:
the magnetic powder is made of the iron element as a main component, and an insulator on a surface of the magnetic powder is formed;
wherein the magnetic powder has a spherical shape or a smoothed surface; and the insulator comprises rare earth fluorides, alkaline metal fluorides, or alkaline earth metal fluorides;
wherein the magnetic powder is compression-molded so that the density of the soft magnetic composite becomes 7.4 g/cm³ or more and 7.8 g/cm³ or less.

13. A method of forming a soft magnetic composite according to claim 12, wherein:
the compression-molded soft magnetic composite is further heated at temperatures of 600 to 700° C.
